(19) United States
(12) Patent Application Publication
(10) Pub. No.: US 2011/0028580 A1
(43) Pub. Date: Feb. 3, 2011

(54) CARPET BACKING COMPOSITIONS

(76) Inventors: Roger W. Bergman, Midland, MI (US); John M. McClurken, Dalton, GA (US)

Correspondence Address: The Dow Chemical Company;Brooks, Cameron, PLLC, 1221 Nicollet Avenue, Suite 500, Minneapolis, MN, 55403, US

(21) Appl. No.: 12/735,838

(22) PCT Filed: Feb. 3, 2009
(86) PCT No.: PCT/US2009/000675

§ 371 Date: Oct. 12, 2010

Related U.S. Application Data
(60) Provisional application No. 61/067,621, filed on Feb. 29, 2008.

(51) Int. Cl. C08L 33/08; C08J 9/00

(52) U.S. Cl. 521/149; 524/523

(57) ABSTRACT

The present disclosure provides embodiments of aqueous compositions comprising a dispersed polymer for preparing a carpet backing, methods for producing a carpet product, and methods for preparing a polymer-backed carpet. The aqueous composition can be prepared by polymerizing monomers including at least 50 percent by weight of at least one compound selected from the group consisting of alkyl acrylates and alkyl methacrylates having at least 4 carbon atoms in the alkyl. at least 30 percent by weight of at least one compound selected from the group consisting of styrene and alkyl acrylates and alkyl methacrylates having not more than 3 carbon atoms in the alkyl, less than 3 percent by weight of a hydroxyalkyl acrylate, and a copolymerizable acid in an amount up to 5 percent by weight.

### FIELD OF THE DISCLOSURE

The present disclosure relates generally to aqueous compositions for carpet applications, and more particularly to aqueous compositions comprising a dispersed polymer for preparing carpet backings.

### BACKGROUND

Carpets generally include a primary backing with yarn tufts in the form of cut or uncut loops extending upwardly from the backing to form a pile surface. In the case of tufted carpets, the yarn is inserted into a primary backing by tufting needles and then a pre-coat, or binder, is applied thereto. In the case of non-tufted, or bonded pile carpets, the fibers are embedded and actually held in place by the pre-coat.

In some instances, the pre-coat can also contain an adhesive to adhere the carpet to additional layers or the subfloor. Such additional layers can include a laminate layer, a secondary layer, and/or a foam layer. The secondary layer, or secondary backing, optionally bonded to the primary backing, can provide extra padding to the carpet, absorb noise, add dimensional stability, and often can function as a heat insulator. In addition, the variety of subfloors to which the carpet can be applied include wood, concrete, and/or tile, among other types.

Precoats have been prepared from several materials, including from a polyurethane material or styrene-butadiene latex. Regardless of the type of material used to make the precoat, however, the physical properties of the pre-coat are important to successful utilization as a carpet backing coating. For example, the pre-coat can affect the carpet's tuft bind, hand, delaminating properties, wet strength properties, wear resistance, and barrier performance.

In addition, the pre-coat must be capable of being applied to the carpet and dried using the processes and equipment conventionally employed in the carpet industry. It must also provide excellent adhesion to the pile fibers to secure them firmly to the backing, both in tufted and non-tufted constructions. The coating must also have low smoke density values and high flame retardant properties and must accept a high loading of traditional fillers such as calcium carbonate, aluminum trihydrate, barite, and feldspar. Furthermore, the coating must maintain sufficient softness and flexibility, even with high filler loading or at low temperatures, to enable the carpet, if prepared in broadloom form, to be easily rolled and unrolled during installation. The softness and flexibility properties will vary depending on the style of carpet but, in all cases, it is important that the carpet will lie flat and not exhibit a tendency to curl or dome.

There is also an increasing desire to incorporate recycled content into both broadloom carpet and carpet tiles. However, while there has been some success in incorporating recycled content into backing systems like polyvinylchloride or polyurethane based systems, latex-based systems have exhibited instability to recycled content.

It would be desirable to prepare a carpet backing composition for use in the manufacture of carpet and carpet tile, such that the carpet backing composition would exhibit stability to recycled fillers.

### SUMMARY

Embodiments of the present disclosure relate to carpet backing compositions, which may also be described as carpet coating compositions, that may include at least 50 percent by weight of at least one compound selected from the group consisting of alkyl acrylates and alkyl methacrylates having at least 4 carbon atoms in the alkyl, at least 30 percent by weight of at least one compound selected from the group consisting of styrene and alkyl acrylates and alkyl methacrylates having not more than 3 carbon atoms in the alkyl, less than 3 percent by weight of a hydroxyalkyl acrylate, and a copolymerizable acid in an amount up to 5 percent by weight. The carpet backing compositions may also include thickeners, pigments, fillers, and other copolymerizable monomers.

Another aspect of the disclosure includes carpet products made using the carpet backing compositions disclosed herein. A method for producing a carpet product that makes use of the carpet backing compositions is also contemplated.

Compared to known carpet backing compositions, the compositions of the present disclosure exhibit increased dry strength, wet strength, flexibility, stability to recycled fillers, and water barrier properties to the carpet.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DEFINITIONS

For the purposes of the present disclosure, the term “dry” means in the substantial absence of water and the term “dry basis” refers to the weight of a dry material.

For the purposes of the present disclosure, the term “copolymer” means a polymer derived from more than one species of monomer.

For the purposes of the present disclosure, the term “(meth)” indicates that the methyl substituted compound is included in the class of compounds modified by that term. For example, the term (meth)acrylic acid represents acrylic acid and methacrylic acid.

As used herein, “pphm” is an abbreviation for parts by weight per 100 parts by weight of the monomers.

As used herein “° C.” is an abbreviation for degrees Celsius.

As used herein “g” is an abbreviation for gram(s).

As used herein “cP” is an abbreviation for centipoise.

As used herein “cc” is an abbreviation for cubic centimeter.

As used herein, “alkyl” refers to a hydrocarbon group having the general formula CₙH₂ₙ₊₁, where n is the number of carbon atoms.

As used herein, “recycled filler” refers to a filler formed of a product that has been processed and/or reconditioned to adapt the product for a new, secondary use and/or a filler formed of a byproduct of other processes (e.g., industrial applications).

As used herein, “a,” “an,” “the,” “at least one,” and “one or more” are used interchangeably. The terms “comprises” and variations thereof do not have a limiting meaning where these terms appear in the description and claims. Thus, for example, a carpet backing composition that comprises “a” hydroxyalkyl acrylate can be interpreted to mean that the hydroxyalkyl acrylate includes “one or more” hydroxyalkyl acrylates. Also herein, the recitations of numerical ranges by endpoints include all numbers subsumed within that range (e.g., 1 to 5 includes 1, 1.5, 2, 2.75, 3, 3.80, 4, 5, etc.).

### DETAILED DESCRIPTION

The present disclosure provides embodiments of aqueous compositions comprising a dispersed polymer for preparing a carpet backing, carpet backing compositions, methods for producing a carpet product, and methods for preparing a polymer-backed carpet. As discussed herein, the use of compositions of the present disclosure allows for a carpet backing or carpet product with stability to recycled fillers.

As used herein, an “aqueous composition comprising a dispersed polymer” can be used to prepare a carpet backing. As used herein, the term “carpet backing composition,” or “aqueous composition” refers to the aqueous composition comprising a dispersed polymer used to prepare the carpet backing, or carpet product, unless stated otherwise.

The aqueous compositions comprising the dispersed polymer used to prepare the carpet backing of the present disclosure can be prepared by the polymerization of at least two monomers. For example, the aqueous composition can include at least 50 percent by weight of at least one compound selected from the group consisting of alkyl acrylates and alkyl methacrylates having at least 4 carbon atoms in the alkyl and at least 30 percent by weight of at least one compound selected from the group consisting of styrene and alkyl acrylates and alkyl methacrylates having not more than 3 carbon atoms in the alkyl. The aqueous composition also includes less than 3 percent by weight of a hydroxyalkyl acrylate and a copolymerizable acid in an amount up to 5 percent by weight.

Examples of the group consisting of alkyl acrylates and alkyl methacrylates having at least 4 carbons in the alkyl include, C₄-C₁₀ alkyl esters of (meth)acrylic acid, C₄-C₁₀ alkyl esters of alpha, beta-ethylenically unsaturated C₄-C₆ monocarboxylic acids, C₄-C₁₀ dialkyl esters of alpha, beta-ethylenically unsaturated C₄-C₈ dicarboxylic acids, and vinyl esters of carboxylic acids, including, without limitation, vinyl isobutyrate, vinyl-2-ethyl-hexanoate, vinyl propionate, vinyl isooctanoate and vinyl versatate. Preferred compounds include butyl acrylate, 2-ethyl hexyl acrylate, decyl acrylate, dibutyl maleate and dioctyl maleate, with butyl acrylate being most preferred.

As discussed herein, the aqueous composition can include at least 50 percent by weight of at least one compound selected from the group consisting of alkyl acrylates and alkyl methacrylates having at least 4 carbon atoms in the alkyl. In some embodiments, the aqueous composition can include at least one compound selected from the group consisting of alkyl acrylates and alkyl methacrylates having at least 4 carbon atoms in the alkyl in a range of about 50 to about 66 percent by weight. Further, in various embodiments, the aqueous composition can include butyl acrylate in a range of about 55 to about 60 percent by weight, based on total composition weight.

In some embodiments, the aqueous composition can be formed by including at least 50 percent by weight of at least one compound selected from the group consisting of alkyl acrylates and alkyl methacrylates having a glass transition temperature (T_{g}) less than 10° C. Such compounds include those listed above for those selected from the group consisting of alkyl acrylates and alkyl methacrylates having at least 4 carbon atoms in the alkyl. However, such compounds can further include methyl acrylate and ethyl acrylate, among others.

Examples of the group consisting of styrene and alkyl acrylates and alkyl methacrylates having not more than 3 carbon atoms in the alkyl include styrene, alpha-methyl styrene, vinylidene chloride, methyl methacrylate, dimethyl maleate, acrylonitrile, and vinyl esters of carboxylic acids having a T_{g} of 10° C. or greater. Examples of such vinyl esters include vinyl pivalate, vinyl neodecanoate, vinyl neononanoate, and mixtures of branched vinyl esters such as the commercially available VEOVA 11 and EXXAR NEO-12. Styrene is the most preferred second monomer. In various embodiments, the aqueous composition comprising the dispersed polymer includes copolymerized styrene and butyl acrylate monomers.

As discussed herein, the aqueous composition comprising the dispersed polymer can include at least 30 percent by weight of at least one compound selected from the group consisting of styrene and alkyl acrylates and alkyl methacrylates having not more than 3 carbon atoms. In some embodiments, the aqueous composition can include at least one compound selected from the group consisting of styrene and alkyl acrylates and alkyl methacrylates having not more than 3 carbon atoms in a range of about 35 to about 40 percent by weight. Further, in various embodiments, the aqueous composition can include styrene in a range of about 35 to about 40 percent by weight, based on total composition weight.

In some embodiments, the aqueous composition can be formed by including at least 30 percent by weight of at least one compound selected from the group consisting of styrene and alkyl acrylates and alkyl methacrylates whose homopolymers have a T_{g} greater than or equal to 10° C. Such compounds include those listed above for those selected from the group consisting of styrene and alkyl acrylates and alkyl methacrylates having not more than 3 carbon atoms in the alkyl, among others having a T_{g} greater than or equal to 10° C.

The aqueous composition comprising the dispersed polymer also includes a copolymerizable acid in an amount up to 5 percent by weight. For example, the copolymerizable acid can include itaconic acid, fumaric acid, acrylic acid, methacrylic acid, the half esters of maleic acid, such as monoethyl monobutyl, or monooctyl maleate. The preferred copolymerizable acid is methacrylic acid. In some embodiments, the aqueous composition can include the copolymerizable acid in a range of about 2 to about 4 percent by weight. Additionally, in various embodiments, the aqueous composition can include about 3 percent by weight, based on total composition weight, of methacrylic acid.

The aqueous composition comprising the dispersed polymer also includes less than 3 percent by weight, based on total composition weight, of a hydroxyalkyl acrylate. In some embodiments, the aqueous composition can include hydroxyalkyl acrylate in a range of about 0.5 to about 3 percent by weight, based on total composition weight. The hydroxyalkyl acrylate can be hydroxyethyl acrylate, hydroxypropyl acrylate, and/or hydroxyethyl methacrylate. In various embodiments, the aqueous composition can include about 1 percent by weight, based on total composition weight, of hydroxyethyl methacrylate.

In some embodiments, it may also be desirable to incorporate, in the aqueous composition comprising the dispersed polymer, one or more functional comonomers. Suitable functional comonomers include, for example: acrylamide; tertiary octylacrylamide; N-methylol (meth)acrylamide; N-vinylpyrrolidinone; diallyl adipate; triallyl cyanurate; butanediol diacrylate; and allyl methacrylate. The functional comonomer generally is used at levels of less than 5 pphm, preferably less than 3 pphm, depending upon the nature of the specific comonomer.

In addition, certain copolymerizable monomers that assist in the stability of the aqueous composition, e.g., vinyl sulfonic acid, sodium vinyl sulfonate, sodium styrene sulfonate, sodium allyl ether sulfate, sodium 2-acrylamide-2-methyl-propane sulfonate (AMPS), 2-sulfoethyl methacrylate, and 2-sulfopropyl methacrylate, can be employed as emulsion stabilizers. These optional monomers, if employed, can be added in amounts from about 0.1 pphm to about 2 pphm.

The aqueous composition comprising the dispersed polymer of the present disclosure can also be called a “synthetic latex.” A synthetic latex, as is well known, is an aqueous composition of dispersed polymer particles prepared by emulsion polymerization of one or more monomers. Methods for preparing synthetic latexes are known in the art and these procedures can be used.

Suitable free radical polymerization initiators are the initiators capable of promoting emulsion polymerization and include water-soluble oxidizing agents, such as, organic peroxides (e.g., t-butyl hydroperoxide, cumene hydroperoxide, etc.), inorganic oxidizing agents (e.g., hydrogen peroxide, potassium persulfate, sodium persulfate, ammonium persulfate, etc.), and those initiators that are activated in the water phase by a water-soluble reducing agent. Such initiators are employed in an amount sufficient to cause polymerization. Generally, a sufficient amount is from about 0.1 pphm to about 5 pphm. Alternatively, redox initiators may be employed, especially when polymerization is carried out at lower temperatures. For example, reducing agents may be used in addition to the persulfate and peroxide initiators mentioned above. Typical reducing agents include, but are not limited to: alkali metal salts of hydrosulfites, sulfoxylates, thiosulfates, sulfites, bisulfites, reducing sugars such as glucose, sorbose, ascorbic acid, erythorbic acid, and the like. In general, the reducing agents are used at levels from about 0.01 pphm to about 5 pphm. Many of such initiators are known to those skilled in the art. Mixtures of initiators can be employed.

For the purposes of this disclosure, a surfactant can be a component of the aqueous composition comprising the dispersed polymer, e.g., was used in the reactor during polymerization of the polymeric composition. The surfactant can be the surfactants generally used in emulsion polymerization. The surfactant can be anionic, nonionic, or mixtures thereof. The terms “surfactant,” “emulsifying agent,” and “emulsifier” are used interchangeably herein.

Suitable nonionic emulsifiers include polyoxyethylene condensates. Exemplary polyoxyethylene condensates that can be used include polyoxyethylene aliphatic ethers, such as polyoxyethylene lauryl ether and polyoxyethylene oleyl ether; polyoxyethylene alkaryl ethers, such as polyoxyethylene nonylphenol ether and polyoxyethylene octylphenol ether; polyoxyethylene esters of higher fatty acids, such as polyoxyethylene laurate and polyoxyethylene oleate, as well as condensates of ethylene oxide with resin acids and tall oil acids; polyoxyethylene amide and amine condensates such as N-polyoxyethylene lauramide, and N-lauryl-N-polyoxyethylene amine and the like; and polyoxyethylene thio-ethers such as polyoxyethylene n-dodecyl thio-ether.

Nonionic emulsifying agents that can be used also include a series of surface active agents available from BASF under the PLURONIC and TETRONIC trade names. In addition, a series of ethylene oxide adducts of acetylenic glycols, sold commercially by Air Products under the SURFYNOL trade name, are suitable as nonionic emulsifiers.

Suitable anionic emulsifiers include the alkyl aryl sulfonates, alkali metal alkyl sulfates, the sulfonated alkyl esters, and fatty acid soaps. Specific examples include sodium dodecylbenzene sulfonate, sodium butylnaphthalene sulfonate, sodium lauryl sulfate, disodium dodecyl diphenyl ether disulfonate, N-octadecyl sulfosuccinate and dioctyl sodiumsulfosuccinate. The emulsifiers are employed in amounts effective to achieve adequate emulsification of the polymer in the aqueous phase and to provide desired particle size and particle size distribution.

Other ingredients known in the art to be useful for various specific purposes in emulsion polymerization, such as, acids, salts, chain transfer agents, chelating agents, buffering agents, neutralizing agents, defoamers, and plasticizers also may be employed in the preparation of the aqueous composition. For example, if the polymerizable constituents include a monoethylenically unsaturated carboxylic acid monomer, polymerization under acidic conditions (pH 2 to pH 7, preferably pH 2 to pH 5) is preferred. In such instances the aqueous medium can include those known weak acids and their salts that are commonly used to provide a buffered system at the desired pH range.

Various protective colloids may also be used in place of or in addition to the emulsifiers described above. Suitable colloids include casein, hydroxyethyl starch, carboxyxethyl cellulose, carboxymethyl cellulose, hydroxyethylcellulose, gum arabic, alginate, poly(vinyl alcohol), polyacrylates, polymethacrylates, styrene-maleic anhydride copolymers, polyvinylpyrrolidones, polyacrylamides, polyethers, and the like, as known in the art of emulsion polymerization technology. In general, when used, these colloids are used at levels of 0.05 percent to 10 percent by weight, based on the total weight of the reactor contents.

The manner of combining the polymerization ingredients can be by various known monomer feed methods, such as, continuous monomer addition, incremental monomer addition, or addition in a single charge of the entire amounts of monomers. The entire amount of the aqueous medium with polymerization additives can be present in the polymerization vessel before introduction of the monomers, or alternatively, the aqueous medium, or a portion of it, can be added continuously or incrementally during the course of the polymerization.

Following polymerization, the solids content of the resulting aqueous polymer binder dispersion can be adjusted to the level desired by the addition of water or by the removal of water by distillation. Generally, the desired level of aqueous composition solids content is from about 40 weight percent to about 75 weight percent, based on the total weight of the aqueous dispersed polymeric composition, more preferably from about 50 weight percent to about 70 weight percent, based on the total weight of the aqueous composition.

As discussed herein, embodiments of the present disclosure include compositions that exhibit stability to fillers. The filler employed can be a filler suitable for use in carpet manufacture. Examples of mineral fillers or pigments that can be incorporated into compositions of the present disclosure include those known in the art, such as calcium carbonate, ground glass, clay, kaolin, talc, barites, feldspar, titanium dioxide, calcium aluminum pigments, satin white, synthetic polymer pigment, zinc oxide, barium sulphate, gypsum, silica, alumina trihydrate, mica, hollow polymer pigments, and diatomaceous earth. Mixtures of fillers can also be employed.

The amount of filler that is employed in the preparation of the carpet backing composition can vary depending upon the density of the filler and the coating properties desired. The amount of filler employed in the carpet backing composition of the present disclosure advantageously can be from about 50 to about 800 dry weight parts per 100 dry weight parts of polymer solids, and preferably from about 100 to about 600 dry weight parts per 100 dry weight parts of polymer solids.

In addition, embodiments of the present disclosure include carpet backing compositions including recycled fillers. As discussed herein, there is an increasing desire to incorporate recycled content into both broadloom carpet and carpet tiles. For example, there are many initiatives, including US Green Building Council's Leadership in Energy and Environmental Design (LEED), which are environmentally driven while promoting the use of recycled content in construction products. As such, recycled materials are being evaluated for fibers in both the backing and the face, as well as for filler in the carpet backing composition to replace calcium carbonate. Coal fly ash (CFA) is a filler that has been evaluated for many years as a recycled filler for use in carpet backing compositions. Coal fly ash is a powdery material made up of tiny glass spheres and consists primarily of silicon, aluminum, iron, and calcium oxides. It is a byproduct of burning coal at electric utility plants.

While there has been some success in incorporating CFA into backing systems like polyvinylchloride or polyurethane based systems, latex-based systems have exhibited instability to CFA in two ways. The first is an impractical rise in viscosity, usually to the point of gelation, when CFA is incorporated into a latex-containing carpet compound. This gelation generally occurs in the first 24 hours after production. The second way is exhibited by exposing a film of backing compound to a heat age test. When a CFA-containing film is exposed to heat, it can become brittle within 48 hours, and usually within 24 hours. The industry standard for carpet compound is for it to maintain flexibility for 4 days, while most remain flexible for 6 to 8 days.

Embodiments of the present disclosure, however, exhibit stability when a recycled filler, e.g., CFA, is incorporated into the carpet backing composition. In some embodiments, the carpet backing composition can include recycled filler in a range of 0 parts to about 400 dry parts per 100 parts of polymer solids. In such embodiments, the stability of the carpet backing compositions including recycled fillers can be shown by having a low viscosity measured after the filler is dispersed and low viscosity build, as discussed in the example section herein.

If desired, conventional additives may be incorporated into the carpet backing compound of the present disclosure in order to modify the properties thereof. Examples of these additives include surfactants, thickeners, catalysts, dispersants, colorants, biocides, anti-foaming agents, and the like.

A carpet backing composition of the present disclosure advantageously can be used in the production of conventional tufted carpet, non-tufted carpet, and needle-punched carpet and can be dried using equipment that is known to those skilled in the art, such as that used in carpet mills. Thus, the carpet backing composition may be useful in the production of pile carpets having a primary backing with pile yarns extending from the primary backing to form pile tufts; as well as non-tufted carpets wherein the fibers are embedded into the aqueous composition that has been coated onto a woven or non-woven substrate.

The carpet backing composition may be employed in the manufacture of carpet according to techniques well known to those skilled in the art.

In preparing a tufted carpet, the yarn is tufted or needled into a primary backing, which is generally non-woven polypropylene, polyethylene or polyester or woven jute or polypropylene. If a secondary backing is used, it is generally formed of woven or non-woven materials similar to those used as the primary backing. Such a secondary backing can provide dimensional stability to the carpet. The secondary backing can be in the form of a foam polymer or copolymer. Suitable foam compositions include urethane polymers, polymers and copolymers of ethylene, propylene, isobutylene, and vinyl chloride. When a foam secondary backing is used, it can be prefoamed and then laminated onto the primary backing. The foam secondary backing can also contain a thermally activatable blowing agent and can be foamed immediately prior to lamination or after lamination. Additionally, the secondary backing can exhibit thermoplastic adhesive properties of its own, and the secondary backing can be preheated prior to lamination to render the surface thereof adhesive. Alternatively, the secondary backing can be a hot melt, one or more of fused PVC plastisol layer(s) or bitumen, often in conjunction with fiberglass scrim or other scrim known to provide dimensional stability. It is also contemplated that the compositions disclosed herein can be used as the pre-coat and as the secondary backing. The pre-coat layer can optionally be dried before the secondary backing is applied. The secondary backing can be applied to either the precoated griege or to the secondary backing.

In forming a non-tufted carpet, the carpet coating composition is generally thickened to a viscosity of about 2,000 cP to about 75,000 cP and applied to a scrim surface. The fibers then are directly embedded into the wet coating using conventional techniques and then dried. Again, a secondary coating similar to that described above is desirably employed.

The composition of the disclosure is easier to apply to the carpet than hot melt thermoplastic adhesives that require expensive and complex machines and processes to apply a coating, and the coating also penetrates the fibers of the carpet yarns to yield better adhesion, fiber bundle integrity, and anti-fuzzing properties. The term “tuft-bind” refers to the ability of the carpet coating composition to lock and secure the pile yarn tufts to the primary backing and is determined as set forth herein. Tuft-bind is also used to include the superior characteristics needed in non-tufted coatings wherein the adhesion of the fiber pile is achieved solely by the backing. Suitable tuft-bind properties can be achieved by applying an amount of the carpet coating composition ranging from about 10 ounces per square yard to about 40 ounces per square yard (dry basis), which results in a carpet having a tuft-bind value of at least 6 pounds force for loop carpet (3 pounds for cut pile), and in many instances a tuft-bind value of 15 pounds force or greater.

The present disclosure also provides a method of preparing a pile or tufted carpet that may include tufting or needling the yarn into a woven or non-woven backing; applying the frothed carpet backing composition of the present disclosure to the rear of the carpet backing such that the yarn is embedded in the carpet backing composition; and drying the carpet backing composition applied to the carpet backing.

In producing such tufted carpets it is also desirable to apply a secondary backing to the primary backing either before or after drying of the carpet pre-coat, depending upon the type of backing employed. It is also possible to employ an additional frothed or unfrothed coating to the carpet griege or secondary backing during carpet manufacture.

Non-tufted carpets also can be prepared utilizing the carpet backing compositions of the disclosure by a method that can include coating a composition of the present disclosure onto a substrate; embedding the carpet fibers in the substrate; and drying the resultant carpet construction.

These non-tufted carpets also can be advantageously prepared utilizing a secondary backing to provide additional dimensional stability.

As discussed herein, the aqueous composition comprising the dispersed polymer can be used to prepare a carpet backing. In addition, embodiments of the present disclosure include methods for producing a carpet product including using the aqueous composition comprising the dispersed polymer to produce the carpet product. In some embodiments, a spill resistant carpet backing can be prepared using the aqueous composition comprising the dispersed polymer. In such embodiments, the spill resistant carpet backing can be a carpet layer selected from the group consisting of a precoat, a laminate layer, and a foam layer.

Carpet prepared using the carpet backing composition of the disclosure advantageously can contain recycled content that results in a more environmentally friendly product. This environmentally friendly carpet makes it easier for specifiers and architects to meet the criteria set forth in various environmentally focused purchasing criteria such as the US Green Building Council's LEED program.

While the present disclosure has been shown and described in detail above, it will be clear to the person skilled in the art that changes and modifications may be made without departing from the spirit and scope of the disclosure. As such, that which is set forth in the foregoing description and accompanying drawings is offered by way of illustration only and not as a limitation. The actual scope of the disclosure is intended to be defined by the following claims, along with the full range of equivalents to which such claims are entitled.

In addition, one of ordinary skill in the art will appreciate upon reading and understanding this disclosure that other variations for the disclosure described herein can be included within the scope of the present disclosure.

The following examples are provided for illustrative purposes and are not intended to limit the scope of the disclosure since the scope of the present disclosure is limited only by the appended claims and equivalents thereof. All parts and percentages are by weight unless otherwise indicated.

### SPECIFIC EMBODIMENTS OF THE DISCLOSURE

The following examples are given to illustrate the invention and should not be construed as limiting in scope. All parts and percentages are by weight unless otherwise indicated.

### Materials

Filler (A): dry calcium carbonate (MW101 is available from Carmeuse Lime and Stone in Chatsworth, Ga.).
Filler (B): Class F Coal Fly Ash (PV 14A available from Boral Industries, Sydney, Australia).
Filler (C): Ground Glass (CRA-80 is available from Container Recycling Alliances in Cornelius, N.C.).
28 percent Ammonium Hydroxide is available from Sigma-Aldrich, Inc. in Milwaukee, Wis.
Thickeners: P-500 and P-241 are available from Para-Chem Standard Division in Dalton, Ga.

### Carpet Sample Preparation

To prepare carpet samples, carpet griege samples are cut to an approximate size dependent on the amount of material available and required test specimens. A 12 inch long×12 inch wide (30.48 centimeters (cm) long×30.48 cm wide) piece of carpet griege is typical. The carpet griege to be coated is then placed face down on a rigid backing plate. Sufficient compound to obtain a coating weight of 32 ounces per square yard (100.88 grams of dry compound or, for example, 129.33 grams of wet compound if the solids percent is 78 percent) is applied to the back of the greige. A 15 inch (38.1 cm) spatula is used to spread the compound evenly over the 12 inch×12 inch carpet greige. A steel rod (1 inch diameter×30 inches long (2.54 cm×76.2 cm), 991 grams) is rolled over the coated griege to uniformly drive the compound into the carpet greige. After the carpet has been coated, it is placed in a 270° F. (132° C.) oven for 20 minutes to dry. After 20 minutes, the carpet is taken out of the oven and put into a constant temperature (70° F. (21° C.)) and humidity (50 percent) for a minimum of 12 hours. The carpet is then tested for dry tuft bind, wet tuft bind, and hand, by the methods described herein.

### Test Methods

The following test procedures are used to evaluate carpet coating compositions of the present disclosure.

Brookfield Viscosity: the viscosity is measured at room temperature using a Brookfield RVT viscometer (available from Brookfield Engineering Laboratories, Inc., Stoughton, Mass., USA). Speed and spindle type are indicated with the corresponding data.

Dry Tuft Bind: The tuft bind is measured to determine how well the yarn is being held into the primary of a tufted carpet and is performed according to ASTM D1335, except that lab prepared test samples are 3 inch×9 inch (7.6 cm×22.9 cm) and are cut from a 9 inch×9 inch (22.9 cm×22.9 cm) coated sample. Three test samples are cut from each coated sample and 3 tufts are pulled from each test sample for a total of 9 pulls per coated sample.

Wet Tuft Bind: The wet tuft bind is measured to determine how well carpet retains its strength after it has been rewet. Carpet is submerged in water for 20 minutes, drained, blotted with a paper towel, and tuft bind measured according to ASTM D1335 with the modifications listed above for Dry Tuft Bind.

Hand: This test measures the flexibility of a finished carpet sample by determining the pounds of force required to deflect the carpet sample 0.5 inches (1.3 cm). The carpet sample 9 inch×9 inch (22.9 cm×22.9 cm) or 9 inch×12 inch (22.9 cm×30.5 cm) is allowed to equilibrate for a minimum of two hours under the desired test conditions. “Normal” conditions are 50 percent (±5 percent) relative humidity and 72° F. (±5° F.) (22° C.) temperature. The test is run by placing a carpet sample face up on a 5.5 inch (13.97 cm) inside diameter hollow cylinder mounted in the bottom fixture of a force measuring device such as Instron Model No. 5500R (available from Instron, Norwood, Mass. USA). A 2.25 inch (5.71 cm) outside diameter solid foot, mounted in the top jaw, is lowered to the face of the carpet until the exerted force registers 0.05 to 0.10 pounds of deflective force, and this is the starting position. The Instron is configured with a Crosshead travel of 0.65 inch (1.65 cm) and the speed of travel is equal to 12.0 inches per minute (in/min) (30.48 cm/min), and the foot is driven into the carpet sample. The force needed to deflect the carpet sample 0.5 inches (1.27 cm) is measured. The sample is then turned over so the face of the carpet is down. The foot is lowered again and another measurement is taken. This process is repeated until 4 measurements are recorded. These measurements are averaged and the average is reported as the Hand of the carpet.

### Coating Compound Preparation

The aqueous compositions comprising the dispersed polymer, or latex binder, are formulated into the carpet backing formulations as set forth in Table 1 below. The compositions are identified as A, B, and C. The amounts in Table 1 are expressed in phr (dry parts/hundred dry parts of latex binder).

TABLE 1

| Description | Formulation A | Formulation B | Formulation C |
|---|---|---|---|
| Latex Binder | 100 | 100 | 100 |
| Filler (A) | 200 | 0 | 0 |
| Filler (B) | 0 | 200 | 0 |
| Filler (C) | 0 | 0 | 200 |
| 28% Ammonium | To pH 8-8.5 | To pH 8-8.5 | To pH 8-8.5 |
| Hydroxide | | | |
| Thickener P-500 | 0.1 | 0.1 | 0.1 |
| Thickener P-241 | To viscosity 14,000-16,000 cP | To viscosity 14,000-16,000 cP | To viscosity 14,000-16,000 cP |
| | (Brookfield #5 | (Brookfield #5 | (Brookfield #5 |
| | spindle @ 20 rpm) | spindle @ 20 rpm) | spindle @ 20 rpm) |

As indicated in Table 1, Formulation A contains calcium carbonate, Formulation B contains coal fly ash (CFA), and Formulation C contains ground glass.

For each of the following examples, the appropriate amount of latex binder (i.e., aqueous composition comprising a dispersed polymer) is weighed into an appropriately sized container. The specified amount of filler is added while mixing, allowing 5 minutes for the filler to disperse. At this time, any slow or poor dispersion of the filler into the latex binder is noted. The filler dispersion is a qualitative measurement based on one skilled in the art working with the compositions. The “after filler viscosity” is measured after the filler has been dispersed for 5 minutes.

Next, the Thickener P-500 is added while mixing and mixed for 5 minutes. Then the Thickener P-241 is added while mixing until the desired viscosity is obtained.

The stability to the fillers is shown by measuring the “after filler viscosity,” the initial viscosity (after addition of the Thickeners P-500 and P-241), the viscosity build at one day, at three days, and at one week, and the reshear viscosity. “Viscosity build” refers to the increase in viscosity of the carpet backing composition over time. The “reshear viscosity” refers to the viscosity obtained after mixing the 1 week aged composition for 5 minutes at 1,500 rotations per minute (rpm).

It is desirable to obtain a low “after filler viscosity” (e.g., preferably less than about 5,000 cP), good filler dispersion, minimum viscosity build, and a reshear viscosity as close as possible to the initial viscosity.

Carpet samples are prepared and each carpet backing formulation is evaluated for end use properties. The data tables from each example identify which latex binder and which filler are used in each sample, as well as the various viscosity values.

### Example 1

In this Example, the effect of varying the copolymerizable acid or hydroxyalkyl acrylate used in the carpet backing composition on stability to fillers is shown. The results are shown in Table 2. All viscosity values are measured at 20 rpm with the Brookfield spindle numbers as indicated.

TABLE 2

| | | Sample | Sample | Sample | Sample | Sample | Sample |
|---|---|---|---|---|---|---|---|
| | | 1 | 2 | 3 | 4 | 5 | 6 |
| Monomer | Butyl Acrylate | 57.7 | 57.7 | 57.7 | 57.7 | 57.7 | 57.7 |
| Comp. | Styrene | 38.3 | 38.3 | 38.3 | 38.3 | 38.3 | 38.3 |
| | Methacrylic acid | | | 3 | 3 | 3 | |
| | Hydroxyethyl acrylate | 1 | 1 | 1 | | | 1 |
| | Itaconic Acid | | | | | | 2.25 |
| | Acrylic Acid | | 2.5 | | | | |
| | Fumaric Acid | 2 | | | | | |
| | Hydroxyethyl | | | | 1 | | |
| | methacrylate | | | | | | |
| | Hydroxypro-pyl acrylate | | | | | 1 | |
| Filler (A) | Viscosity After Filler | 390 | Set Up | 2405 | 1345 | 1975 | 795 |
| | (cP Spindle #3) | | | | | | |
| | Filler Dispersion | Good | Set Up | Good | Good | Good | Good |
| | Initial Viscosity | 15300 | Set Up | 15100 | 15400 | 17450 | 14850 |
| | (cP Spindle #5) | | | | | | |
| | 1 Day Viscosity Build | 13600 | Set Up | 16450 | 15250 | 18450 | 17000 |
| | (cP Spindle #6) | | | | | | |
| | 3 day viscosity Build | 13150 | Set up | 15000 | 15850 | 18150 | 16350 |
| | (cP Spindle #6)) | | | | | | |
| | 1 week viscosity | 12900 | Set up | 14650 | 14350 | 16800 | 15150 |
| | (cP Spindle #6) | | | | | | |
| | Reshear viscosity | 12000 | Set up | 14400 | 13750 | 16000 | 13600 |
| | (cP Spindle #6) | | | | | | |
| Filler (B) | Viscosity After Filler | Set up | 4160 | 1900 | 1120 | 1650 | 2765 |
| | (cP Spindle #3) | | | | | | |
| | Filler Dispersion | Set up | Poor | Medium | Medium | Medium | Good |
| | Initial Viscosity | Set up | 18750 | 16500 | 16050 | 16200 | 17850 |
| | (cP Spindle #5) | | | | | | |
| | 1 Day Viscosity Build | Set up | 17150 | 16300 | 16550 | 17600 | Set up |
| | (cP Spindle #6) | | | | | | |
| | 3 day viscosity Build | Set up | 15000 | 10600 | 11600 | 12300 | Set up |
| | (cP Spindle #6)) | | | | | | |
| | 1 week viscosity | Set up | 12350 | 14050 | 22800 | 23250 | Set up |
| | (cP Spindle #6) | | | | | | |
| | Reshear viscosity | Set up | 6850 | 11300 | 12950 | 12950 | Set up |
| | (cP Spindle #6) | | | | | | |
| Filler (C) | Viscosity After Filler | 430 | Set up | 6320 | 3500 | 4080 | Set up |
| | (cP Spindle #3) | | | | | | |
| | Filler Dispersion | Good | Set up | Good | Good | Good | Set up |
| | Initial Viscosity | 14900 | Set up | 17000 | 18800 | 18300 | Set up |
| | (cP Spindle #5) | | | | | | |
| | 1 Day Viscosity Build | 14400 | Set up | 33500 | 41950 | 35900 | Set up |
| | (cP Spindle #6) | | | | | | |
| | 3 day viscosity Build | 12950 | Set up | 41750 | 54600 | 44400 | Set up |
| | (cP Spindle #6)) | | | | | | |
| | 1 week viscosity | 13100 | Set up | 45000 | 49000 | 45750 | Set up |
| | (cP Spindle #6) | | | | | | |
| | Reshear viscosity | 12100 | Set up | 31550 | 34150 | 34800 | Set up |
| | (cP Spindle #6) | | | | | | |

As shown in Table 2, sample 3 shows that compositions including hydroxyethyl acrylate with methacrylic acid did not show gelation and did not set up in the compositions including Filler (A), Filler (B), or Filler (C). In all three formulation, the “after filler viscosity” is acceptable, and the filler dispersion has a rating of “good.” In the Filler (A) and Filler (B) formulations, sample 3 has a low “viscosity build” and a “reshear viscosity” near that of the “initial viscosity.” In addition, the “viscosity build” and “reshear viscosity” of sample 3 in Filler (C) formulation is high, but tolerable.

Sample 1, including fumaric acid has good viscosity stability when including Fillers (A) or (C). However, sample 1 does not show stability to Filler (B), the recycled filler, since it set up when Filler (B) is added. Sample 2, including acrylic acid, has acceptable stability to Filler (B), but is unstable to Fillers (A) and (C), as indicated by the compound setting up. Also, sample 6, including itaconic acid, is stable to Filler (A), but unstable to Filler (B) and (C), as indicated by the compound setting up. Samples 4 and 5, including hydroxyethyl methacrylate and hydroxyl propyl acrylate show reasonable stability to Fillers (A), (B), and (C).

These data show that compositions containing methacrylic acid show the best stability to Fillers (A), (B), and (C), while other acids may be used in combination with one or two of the fillers. This data also shows that hydroxyethyl methacrylate and hydroxypropyl acrylate may be used in place of hydroxyethyl acrylate and still obtain stability to the three fillers.

### Example 2

In this Example, the effect of varying the methacrylic acid and hydroxyethyl acrylate level on the stability to different fillers is measured. The stability is measured again by measuring the viscosity as described herein. The results are shown in Table 3, as well as a general overview. All viscosity values are measured at 20 rpm with the Brookfield spindle numbers as indicated.

TABLE 3

| | | Sample | Sample | Sample | Sample | Sample | Sample | Sample | Sample |
|---|---|---|---|---|---|---|---|---|---|
| | | 7 | 8 | 9 | 10 | 11 | 12 | 13 | 14 |
| Monomer | Butyl Acrylate | 57.2 | 58.7 | 55.7 | 58.2 | 57.7 | 53.7 | 58.2 | 55.7 |
| Comp. | Styrene | 40.8 | 38.3 | 35.8 | 38.3 | 38.3 | 38.3 | 33.8 | 36.3 |
| | Methacrylic acid | 1 | 3 | 3 | 5 | 3 | 3 | 5 | 3 |
| | Hydroxyethyl acrylate | 1 | 0 | 3 | 1 | 1 | 5 | 3 | 5 |
| Filler (A) | Viscosity After Filler | 640 | 265 | 3145 | 3680 | 2405 | Set Up | Set Up | 11900 |
| | (cP Spindle # 3) | | | | | | | | |
| | Filler Dispersion | Good | Good | Good | Good | Good | Set Up | Set Up | poor |
| | Initial Viscosity | 16900 | 15350 | 15000 | 18300 | 15100 | Set Up | Set Up | 17700 |
| | (cP Spindle # 5) | | | | | | | | |
| | 1 Day Viscosity Build | 20450 | 18100 | 15900 | 22600 | 16450 | Set Up | Set Up | 19700 |
| | (cP Spindle # 6) | | | | | | | | |
| | 3 day viscosity Build | 20150 | 15400 | 16850 | 21950 | 15000 | Set Up | Set Up | 22550 |
| | (cP Spindle # 6) | | | | | | | | |
| | 1 week Viscosity Build | 20000 | 14650 | 16350 | 19850 | 14650 | Set Up | Set Up | 20850 |
| | (cP Spindle #6) | | | | | | | | |
| | Reshear Viscosity | 17150 | 14850 | 14250 | 18350 | 14400 | Set Up | Set Up | 16650 |
| | (cP Spindle #6) | | | | | | | | |
| Filler (B) | Viscosity After Filler | 645 | 390 | 1935 | 2410 | 1900 | Set Up | Set Up | 6200 |
| | (cP Spindle # 3) | | | | | | | | |
| | Filler Dispersion | Medium | Good | Medium | Medium | Medium | Set Up | Set Up | Poor |
| | Initial Viscosity | 17800 | 18550 | 15350 | 18600 | 16500 | Set Up | Set Up | 15850 |
| | (cP Spindle # 5) | | | | | | | | |
| | 1 Day Viscosity Build | 15280 | 28250 | 19050 | 20700 | 16300 | Set Up | Set Up | 18400 |
| | (cP Spindle # 6) | | | | | | | | |
| | 3 day viscosity Build | 11170 | Set Up | 11600 | 18450 | 14250 | Set Up | Set Up | 16900 |
| | (cP Spindle # 6) | | | | | | | | |
| | 1 week Viscosity Build | Set up | Set Up | 11500 | 18450 | 14050 | Set Up | Set Up | 14250 |
| | (cP Spindle #6) | | | | | | | | |
| | Reshear Viscosity | Set up | Set Up | 8650 | 16550 | 11300 | Set Up | Set Up | 10600 |
| | (cP Spindle #6) | | | | | | | | |
| Filler (C) | Viscosity After Filler | 990 | 1740 | 8300 | 6760 | 6320 | Set Up | Set Up | 27600 |
| | (cP Spindle # 3) | | | | | | | | |
| | Filler Dispersion | Good | Good | Good | Good | Good | Set Up | Set Up | Poor |
| | Initial Viscosity | 16500 | 16550 | 17350 | 15400 | 17000 | Set Up | Set Up | Set up |
| | (cP Spindle # 5) | | | | | | | | |
| | 1 Day Viscosity Build | 22050 | 25600 | 26750 | 29400 | 33500 | Set Up | Set Up | Set up |
| | (cP Spindle # 6) | | | | | | | | |
| | 3 day viscosity Build | 20300 | 27250 | 31350 | 36800 | 41750 | Set Up | Set Up | Set Up |
| | (cP Spindle # 6) | | | | | | | | |
| | 1 week Viscosity Build | 19600 | 28650 | 34100 | 43800 | 45000 | Set Up | Set Up | Set Up |
| | (cP Spindle #6) | | | | | | | | |
| | Reshear Viscosity | 17900 | 24000 | 25850 | 24450 | 31550 | Set Up | Set Up | Set Up |
| | (cP Spindle #6) | | | | | | | | |
| Overall | Filler (A) | Excellent | Good | Excellent | Excellent | Excellent | Bad | Bad | Poor |
| Assessment | Filler (B) | Bad | Bad | Poor | Excellent | Ok | Bad | Bad | Ok |
| | Filler (C) | Excellent | Ok | Poor | Poor | Poor | Bad | Bad | bad |

As shown in Table 3, almost all of the Samples have “good” stability values for Filler (A) with the exception of samples 12 and 13 which included 3 parts or more of both methacrylic acid and hydroxyethyl acrylate. Samples 10, 11, and 14 have “ok” to “excellent” stability values for Filler (B), with each containing hydroxyethyl acrylate in an amount of at least 1 weight percent, based on total composition, and methacrylic acid in an amount 3 weight percent, based on total composition, or more. However, Sample 14 shows a “poor” value for filler dispersion.

Samples 7 and 8 have “ok” to “excellent” stability values for Filler (C), with both containing hydroxyl ethyl acrylate and methacrylic acid in an amount of at least 1 weight percent, based on total composition.

### Example 3

This example is similar to Example 2 except that the stability to calcium carbonate is not tested for the compositions. The results are shown in Table 4. All viscosity values are measured at 20 rpm with the Brookfield spindle numbers as indicated.

TABLE 4

| | | Sample | Sample | Sample | Sample |
|---|---|---|---|---|---|
| | | 15 | 16 | 17 | 18 |
| Monomer | Butyl Acrylate | 57.7 | 57.7 | 58.2 | 54.7 |
| Composition | Styrene | 38.3 | 41.3 | 36.8 | 41.3 |
| | Methacrylic acid | 3 | 1 | 5 | 1 |
| | Hydroxyethyl acrylate | 1 | 0 | 0 | 3 |
| Filler (A) | Did Not Test | | | | |
| Filler (B) | Viscosity After Filler | 675 | 1225 | 1445 | 480 |
| | (cP Spindle # 3) | | | | |
| | Filler Dispersion | Good | Poor | Good | Good |
| | Initial Viscosity | 17700 | Set up | 16220 | 14100 |
| | (cP Spindle # 5) | | | | |
| | 1 Day Viscosity Build | 26900 | Set up | 20000 | 45600 |
| | (cP Spindle # 6) | | | | |
| | 3 day viscosity Build | 31500 | Set Up | 22200 | 44800 |
| | (cP Spindle # 6) | | | | |
| | 1 week Viscosity Build | 75600 | Set up | 18000 | 47400 |
| | (cP Spindle #6) | | | | |
| | Reshear Viscosity | 26000 | Set up | 13750 | 14200 |
| | (cP Spindle #6) | | | | |
| Filler (C) | Viscosity After Filler | 920 | 1065 | 2465 | 595 |
| | (cP Spindle # 3) | | | | |
| | Filler Dispersion | Good | Good | Good | Good |
| | Initial Viscosity | 13700 | 15150 | 14000 | 13300 |
| | (cP Spindle # 5) | | | | |
| | 1 Day Viscosity Build | 17150 | 21950 | 16150 | 14700 |
| | (cP Spindle # 6) | | | | |
| | 3 day viscosity Build | 15400 | 20400 | 15400 | 14000 |
| | (cP Spindle # 6) | | | | |
| | 1 week Viscosity Build | 15750 | 21000 | 16600 | 14000 |
| | (cP Spindle #6) | | | | |
| | Reshear Viscosity | 13600 | 15400 | 14250 | 13250 |
| | (cP Spindle #6) | | | | |

As shown in Table 4, varying the amount of methacrylic acid and hydroxyethyl acrylate can have a substantial effect on the stability to the recycled fillers. For example, Sample 16 does not contain hydroxyethyl acrylate and a low level of methacrylic acid, and the carpet backing composition set up. However, Sample 17 does not contain hydroxyethyl acrylate and a high level of methacrylic acid, with respect to Sample 16, and has low viscosity levels after addition of Filler (B). In addition, Sample 15 contains 1 weight percent hydroxyethyl acrylate, based on total composition weight, and 3 weight percent methacrylic acid, based on total composition weight, and shows good stability to Filler (B).

The effect of varying the amount of methacrylic acid and hydroxyethyl acrylate on stability to Filler (C) is less pronounced, as shown in Table 4. Each of the samples, 15-18, show good filler dispersion and relatively similar viscosity levels with Filler (C).

Table 5 illustrates a qualitative assessment of a number of the carpet backing compositions, where properties such as viscosity, filler stability, and filler dispersion are all taken into account. A rating of “good” means that the stability to the filler is good. A rating of “ok” indicates that the stability to the filler is ok, but not the most desired. A rating of “poor” indicates that the stability is poor and not likely usable. A rating of “bad” indicates that stability is bad and definitely not useable.

TABLE 5

| | | MAA Level | | | | | | | | |
|---|---|---|---|---|---|---|---|---|---|---|
| | | 1 | | | 3 | | | 5 | | |
| | | Filler | Filler | Filler | Filler | Filler | Filler | Filler | Filler | Filler |
| | | A | B | C | A | B | C | A | B | C |
| HEA | 0 | | Bad | Good | Ok | Poor | Ok | | Good | Good |
| Level | 1 | Good | Poor | Good | Good | Good | Good | Good | Good | Poor |
| | 3 | | Poor | Ok | Good | Ok | Poor | Bad | Bad | Bad |
| | 5 | | | | Poor | Poor | Bad | | | |

As shown in Table 5, a level of about 3 parts of methacrylic acid and about 1 part of hydroxyethyl acrylate gives the best overall stability to the three fillers. If one increases or decreases the level of methacrylic acid or hydroxyethyl acrylate from these levels, the stability to one or more fillers is reduced. if the level of methacrylic acid is increased above 3 parts, the stability to ground glass, Filler (C), is poor. If the methacrylic acid level is reduced to 1 part, the stability to Filler (B) is reduced. If the hydroxyethyl acrylate level is reduced to zero, the stability to all fillers is reduced. If the hydroxyethyl acrylate level is increased, the stability to all the fillers is also decreased. As shown, the preferable range for stability to all the fillers is when the composition includes 3 weight percent methacrylcic acid, based on total composition weight, and 1 weight percent hydroxyethyl acrylate, based on total composition weight. If the levels in any direction are adjusted, stability to one or more fillers becomes poorer.

One exception seems to be where there is no hydroxyethyl acrylate present, and high levels of methacrylic acid are present. This high level of methacrylic acid can result in a high latex binder viscosity at the latex binder pH desired for typical carpet formulations (pH 7 to 8.5). At a pH below 7, the possibility of dissolving bases in the fillers can increase, which can raise the viscosity of the carpet backing compositions to an undesirable level.

### Example 4

In this Example, carpet end use properties are evaluated for a carpet backing composition without hydroxyethyl acrylate versus carpet backing compositions with hydroxyethyl acrylate. The results are shown in Table 6.

TABLE 6

| Sample | Hand | Dry TB | Wet TB |
|---|---|---|---|
| Sample 19 | 15 | 16.9 | 14.4 |
| (Styrene/Butyl Acrylate/Methacrylic acid | | | |
| 38.3/57.7/3) | | | |
| Sample 20 | 13.8 | 20.8 | 17.1 |
| (Styrene/Butyl Acrylate/Methacrylic | | | |
| Acid/Hydroxyethyl Acrylate 57.7/38.3/3/1) | | | |
| Sample 21 | 10.8 | 22.6 | 18 |
| (Styrene/Butyl Acrylate/Methacrylic | | | |
| Acid/Hydroxyethyl Acrylate 57.7/38.3/3/1) | | | |

As shown in Table 6, the use of hydroxyethyl acrylate results in higher wet and dry tuft bind, and equal or softer hand.

1. A carpet backing composition, comprising:
an aqueous composition comprising a dispersed polymer, where the polymer is polymerized from monomers comprising:
at least 50 percent by weight, based on total polymer weight, of at least one compound selected from the group consisting of alkyl acrylates and alkyl methacrylates having at least 4 carbon atoms in the alkyl;
at least 30 percent by weight, based on total polymer weight, of at least one compound selected from the group consisting of styrene and alkyl acrylates and alkyl methacrylates having not more than 3 carbon atoms in the alkyl;
0.5 to 3 percent by weight, based on total polymer weight, of a hydroxyalkyl acrylate; and
methacrylic acid in an amount of 1 to 5 percent by weight, based on total polymer weight.

2. The composition of claim 1, where the carpet backing composition contains recycled fillers.

3. The composition of claim 2, where the recycled fillers in the composition are in a range of from 0 to about 400 dry parts per 100 parts of polymer solids.

4. The composition of claim 1, where the composition includes fillers in a range of from 50 to about 800 dry parts per 100 parts of polymer solids.

5. (canceled)

6. The composition of claim 1, where the polymer is polymerized from monomers comprising:
butyl acrylate in a range of about 55 to about 60 percent by weight, based on total polymer weight;
styrene in a range of about 35 to about 40 percent by weight, based on total polymer weight;
about 3 percent by weight, based on total polymer weight, of methacrylic acid; and
about 1 percent by weight, based on total polymer weight, of hydroxyethyl methacrylate.

7.-9. (canceled)

10. A method for preparing a polymer-backed carpet, comprising:
forming an aqueous composition comprising a dispersed polymer, where the dispersed polymer is polymerized from monomers comprising:
at least 50 percent by weight of at least one compound selected from the group consisting of alkyl acrylates and alkyl methacrylates whose homopolymers have a T_{g} less than 10° C.;
at least 30 percent by weight of at least one compound selected from the group consisting of styrene and alkyl acrylates and alkyl methacrylates whose homopolymers have a T_{g} greater than or equal to 10° C.;
0.5 to 3 percent by weight of a hydroxyalkyl acrylate; and
methacrylic acid in an amount of 1 to 5 percent by weight; and
applying the aqueous composition comprising the dispersed polymer to a carpet.

11. The method of claim 10, where forming an aqueous composition includes frothing the aqueous composition with air.

12. The composition of claim 1, where styrene is selected from the group consisting of styrene and alkyl acrylates and alkyl methacrylates having not more than 3 carbon atoms in the alkyl.

13. The composition of claim 1, where butyl acrylate is selected from the group consisting of alkyl acrylates and alkyl methacrylates having at least 4 carbon atoms in the alkyl.

14. The composition of claim 1, where the hydroxyalkyl acrylate is hydroxyethyl acrylate.

15. The composition of claim 1, where the hydroxyalkyl acrylate is hydroxyethyl methacrylate.

16. A spill resistant carpet backing prepared using the aqueous composition comprising the dispersed polymer of claim 1.

17. The spill resistant carpet backing of claim 16, where the spill resistant carpet backing is a carpet layer selected from the group consisting of a precoat, a laminate layer, and a foam layer.
